(19) United States
(12) Patent Application Publication
(10) Pub. No.: US 2003/0233944 A1
(43) Pub. Date: Dec. 25, 2003

(54) Plates for flavouring or ageing wine or other beverage

(76) Inventor: Richard John Sugden, Bega (AU)

Correspondence Address: RICHARD JOHN SUGDEN, SPRINGFIELD RMB 1665, PRINCES HIGHWAY, BEGA, 2550, AU

(21) Appl. No.: 10/177,342

(22) Filed: Jun. 24, 2002

(51) Int. Cl. C12G 1/00

(52) U.S. Cl. 99/277

(57) ABSTRACT

A wine or beverage flavouring or ageing plate is disclosed. The plate consists of oak planks (2) held against a ridged backing plate (3) to form a liquid seal around its perimeter with the aid of a pliable gasket (5) and between each plank by pressure from springs (7).

Wine or beverage is pumped through the narrow space so formed via circulation openings (11) such that turbulent flow causes flavourant compounds in the oak planks (2) to leach into the wine or beverage more rapidly than would otherwise occur. The outside of the oak planks (2) are exposed to the air to facilitate the ageing and softening of the wine or beverage being circulated on their other side.

### CROSS-REFERENCE TO RELATED APPLICATIONS

This application claims its priority date through PCT application (in English) number PCT /AU 00/01609, international filing date Dec. 28, 2000 (Dec. 28, 2000) priority data 65520/99 Dec. 30, 1999 (Dec. 30, 1999) international publication number WO 01/49819 A1 international publication date Jul. 12, 2001 (Dec. 7, 2001) designated states (national) AU, NZ, US, and (regional) European AT, BE, CH, CY, DE, DK, ES, FI, FR, GB, GR, IE, IT, LU, MC, NL, PT, SE, TR,

### STATEMENT REGARDING FEDERALLY SPONSORED RESEARCH AND DEVELOPMENT

Not Applicable

### REFERENCE TO SEQUENCE LISTING ETC

Not Applicable

### BACKGROUND OF THE INVENTION

This invention relates to improvements in methods used for flavouring or ageing wine or other beverages. Storage of wine and other beverages in wood barrels, often fashioned from oak wood, has traditionally been used to bring about an improvement in flavour through the slow diffusion of air through the wood, causing various chemical changes to the contents and also the leaching of some flavourant compounds into the wine or beverage from the wood,

The traditional wood barrel is difficult to clean and inspect and requires replacement regularly at considerable cost.

Attempts have been made to overcome some the these problems by dismantling the barrel and shaving wood from inside the staves or by fitting extra pieces of wood inside to release flavourant compounds. Dismantling a conventional barrel to either shave the staves or add extra pieces of wood requires a reasonably high level of skill and has the added disadvantage that replacement of the outer wood, which may be infected with undesirable microorganisms or have acquired unwanted colour or flavour from its previous contents, does not occur.

A square vat with oak sides has been tried but this still requires wine or must be transferred from tanks into the vat, which must then be lifted and stacked. These units also require cleaning and topping regularly, as with conventional barrels. These vats offer no acceleration of rate of transfer of flavourant compounds from the oak to the wine or beverage.

Other attempts have included the fitting of oak planks inside wine tanks to release flavourant compounds into the wine. This method derives oak flavour but does not soften or age the wine as does a barrel as no diffusion of air takes place. It suffers from the added disadvantage that workers must enter the enclosed space of a wine tank to fix or remove the planks. This requires training, gas monitoring, safety equipment and a safety observer outside the tank.

### DETAILED DESCRIPTION OF THE INVENTION

The problems referred to above are overcome by continuously circulating wine from its tank, past a plate which consists of oak planks held closely to a ridged backing plate, then back into the tank.

In one form of the invention oak planks are held tightly against a ridged stainless steel backing plate such that narrow spaces between the planks and backing plate cause severe turbulence as the wine or beverage is pumped through them. This turbulent movement of wine or beverage causes accelerated leaching of flavourant compounds from the oak planks into the wine or beverage as it circulates and is returned to the tank.

The time required for flavour transfer is thereby considerably reduced. A battery of flavour exchange plates can be used and these may be located at some distance from the tank whose contents are being circulated, perhaps within a coolroom or humidity controlled environment.

### BRIEF DESCRIPTION OF DRAWINGS

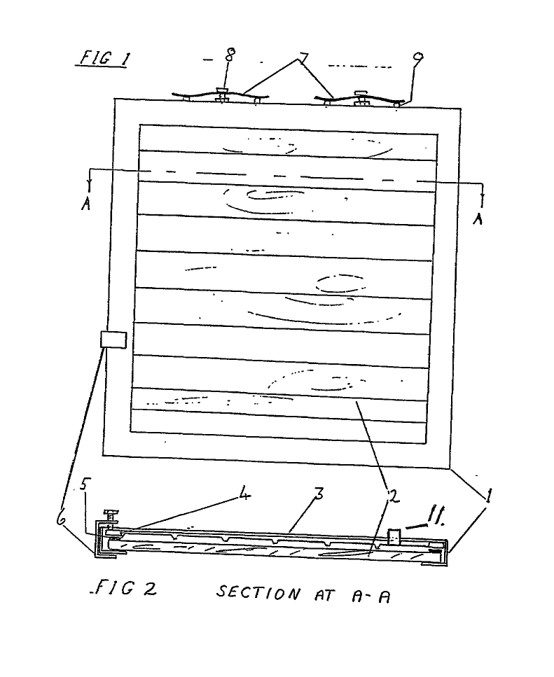

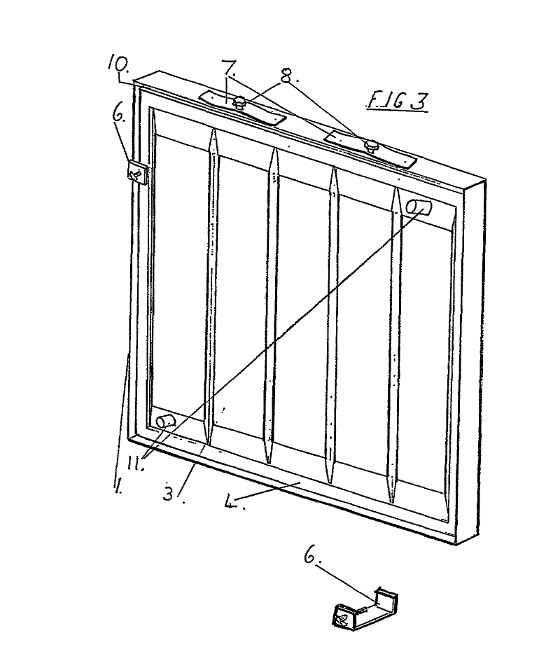

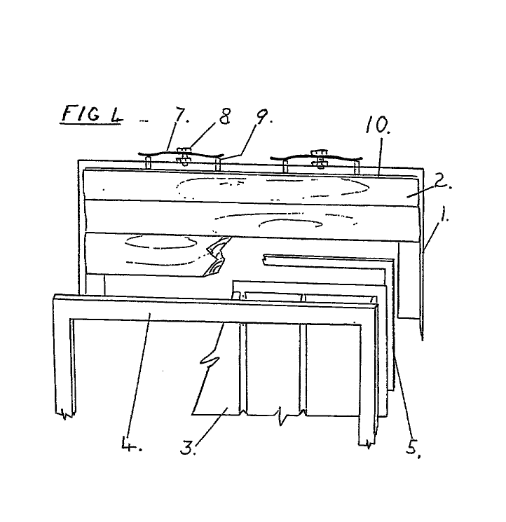

Drawing marked 1/3 shows FIG. 1, front elevation of the flavour exchange plate with straight oak planks in position and pressure springs at top and also FIG. 2, sectional view through A-A. Drawing marked 2/3 shows FIG. 3, an oblique view from the rear with stainless steel backing plate, circulation openings and galvanized steel angle frame and one example of a clamp which may be used to retain these components. Drawing marked 3/3 shows an exploded view from rear with (from bottom to top), galvanized steel backing plate retaining frame, stainless steel backing plate, pliable seal, straight oak planks within the galvanized steel angle frame and detail of pressure springs, pressure spring bolts, pressure string studs and steel pressure strip. Individual part numbers are explained below.

To assist with understanding of the invention reference will now be made to the accompanying drawings which show one example of the invention. A galvanized steel angle frame (1) contains straight oak planks (2) arranged such that each plank abuts the next. Pressure springs (7) and pressure spring bolt (8) exert sufficient pressure through pressure spring studs (9), (which pass through frame (1)), against a steel pressure strip (10) which presses against the oak planks (2) such that each oak plank forms a fluid seal with the adjacent plank.

Held tightly against the oak planks (2) is a ridged stainless steel backing plate (3). The galvanized steel backing plate retaining frame (4) is held tightly in place by a number of backing plate retaining clamps (6). For convenience only one retaining clamp is shown. A fluid seal between the oak planks (2) and ridged stainless steel backing plate (3) is ensured by having a pliable gasket (5) fitted between the two. Wine or beverage is pumped from a tank not shown through the narrow space formed between the planks (2) and stainless steel backing plate (3) via circulation openings (11) located at the top and bottom of the ridged stainless steel backing plate (3) and then back into the tank.

It will be realized that the wine or beverage flavour exchange plate according to this invention is not restricted to using these particular clamping or tensioning devices to hold the components in position nor to the use of oak planks only as the flavouring medium. Any suitable semi-permeable flavouring material could be used to impart its flavour to a wine or beverage being passed over it.

The claims defining the invention are as follows:

1. A wine or beverage flavour exchange plate which is comprised of oak planks or other semi-permeable flavouring material held tightly by clamps against a backing plate such that a liquid seal is formed between the backing plate and oak planks or semi-permeable material around its perimeter and also by spring pressure between the edges of each oak plank or element of semi-permeable material such that when wine or beverage is circulated through the narrow space between the oak planks or semi-permeable material and the backing plate a transfer of flavourant compounds takes place from the oak planks or semi-permeable material into the wine or beverage being circulated.

2. The wine or beverage flavour exchange plate of claim 1. wherein the tensioners applying pressure to the oak planks or semi-permeable material are cams which act against the oak planks or semi-permeable material.

3. The wine or beverage flavour exchange plates of claim 1. wherein the tensioners applying pressure to the oak planks or semi-permeable material are inflatable cuffs which act against the oak planks or semi-permeable material.
